(19) United States
(12) Patent Application Publication
(10) Pub. No.: US 2005/0084217 A1
(43) Pub. Date: Apr. 21, 2005

(54) Optical module capable of transmitting optical signal in bi-directional with single fiber

(76) Inventors: Manabu Yoshimura, Yokohama-shi (JP); Yoshiki Kuhara, Osaka (JP); Hiromi Nakanishi, Osaka (JP)

Correspondence Address: MCDERMOTT WILL & EMERY LLP, 600 13th Street, N.W., Washington, DC, 20005-3096, US

(21) Appl. No.: 10/933,495

(22) Filed: Sep. 3, 2004

(30) Foreign Application Priority Data
Sep. 5, 2003 (JP) 2003-313858

(51) Int. Cl. G02B 6/38; G02B 6/36

(52) U.S. Cl. 385/88

(57) ABSTRACT

The present invention provides an optical module for light-transmitting a first optical signal with a first wavelength and light-receiving a second optical signal with a second wavelength in bidirectional. The optical module of the invention includes an optical fiber, a laser diode, a photodiode, an optical filter and a holder for securing the optical filter. The laser diode emits the first optical signal, while the photodiode receives the second optical signal. The filter reflects one of the first and second optical signals and transmits the other of first and second optical signals. The holder of the present invention includes first and second lens both built in the surface of the holder. The first lens faces the laser diode and optically couples the laser diode with the optical fiber, while the second lens faces the optical fiber. Since the first and second lenses are built in the surface of the holder, the optical alignment of the laser diode and the photodiode can be automatically carried out by mounting the laser diode and the photodiode on the surface of the holder.

### BACKGROUND OF THE INVENTION

1. Field of the Invention

The present invention relates to an optical module, in which a bi-directional optical communication may be carried out with single fiber.

2. Related Prior Art

Recent optical communication system extends to the subscriber system that provides advanced digital services accompanied with a high speed and a wide band information to the subscriber. Such system requires an optical module using single fiber for the bidirectional communication.

FIG. 7 shows an example of the optical module used in such single fiber communication system. The module 100 includes an optical fiber 103, a laser diode (hereinafter denoted as LD) 101, a photodiode (hereinafter denoted as PD) 104, a wavelength selective filter 106, and a housing 112. A lens 102 is disposed between the filter 106 and the LD 101, while another lens 105 is disposed between the filter 106 and the PD 104 to enhance the optical coupling efficiency therebetween. The lens 102 and the LD 101 are assembled in advance as a transmitting optical sub-assembly Similarly, the lens 106 and the PD 104 are assembled in advance as a receiving optical sub-assembly.

According to the arrangement shown in FIG. 7, light emitted from the LD, a wavelength of which is 1.3 μm, is concentrated to the optical fiber 103, passing through the filter 106 by the lens 102. The light provided from the optical fiber 106, the wavelength of which is 1.55 μm, is divided by the filter 106 and enters the PD 104 via the lens 105.

In the conventional module shown in FIG. 7, the optical alignment between devices becomes complicated. For example, optical axes of the optical fiber 103, that of the filter 106, and that of the receiving optical sub-assembly 110 must be aligned to provide light from the optical fiber 103 to the PD 104. Similarly, in order to provide light emitted from the LD 101 to the optical fiber 103, the optical axis of the LD 101, that of the filter 106 and that of the optical fiber 103 must be aligned to each other.

To carry out the optical alignment between devices, extreme precision is required for dimensions and assembly for devices, which directly results on the cost increase. Further, precise alignment of the optical axes of devices causes longer assembling time, which results on the decrease of the productivity. Configuration demanded for the bidirectional optical module is that the structure that enables to optically align the optical fiber, the LD and the PD simultaneously and simply with members without accurate dimensions.

One object of the present invention is to provide such bidirectional module that has the optical fiber, the filter, the LD and the PD, and the optical alignment between devices are carried out with cost effective means and parts.

### SUMMARY OF THE INVENTION

According to one aspect of the present invention, an optical module is provided that includes an optical filter, a holder, a semiconductor light-emitting device, a semiconductor light-receiving device, a coupling member and a first optical element. The light-emitting device may be a laser diode and emits a first optical signal to the coupling member, while the light-receiving device may be a photodiode and receives a second optical signal from the coupling member. The coupling member transmits both the first and the second optical signals therein. The filter is a wavelength selective filter so as to reflect one of the first and the second optical signals and to transmit the other of the first and the second optical signals. The holder secures the filter and provides the first optical element built on the surface thereof and optically coupled with the light-emitting device. Thus, the semiconductor light-emitting device is automatically aligned with the coupling member by being mounted on the surface of the holder.

One of optical configuration of the optical module according to the present invention, the optical axis of the semiconductor light-emitting device may coincide with that of the coupling member, while the optical axis of the light-receiving device may intersect that of the coupling member. In another configuration of the present invention, the optical axis of the light-emitting device intersects that of the coupling member, while the optical axis of the light-receiving device may coincide with that of the coupling member.

The holder of the present invention may provide a groove for securing the optical filter therein, and the optical axis of the optical filter may incline by a half of a right angle to that of the coupling member. Accordingly, one of the light-emitting device and the light-receiving device is mounted on the surface of the holder opposite to a surface facing the coupling member, and the other of the light-emitting device and the light-receiving device is mounted on a surface making by a right angle to the surface facing the coupling member.

The first optical element built in the surface of the holder may be a convex lens or a Fresnel lens. Further, the holder may provide a depression within which the first optical element is built in and the light-emitting device is mounted on the surface thereof so as to overlay the depression. Accordingly, a surface of the first optical element can be protected for the light-emitting device from being in contact with the surface of the first optical element.

The optical module of the present invention may further include a second optical element on a surface of the holder facing the coupling member. In this optical configuration, the first optical signal emitted from the light-emitting device and converted to a substantially parallel beam may converge on the coupling member by the second optical element, while the second optical signal provided from the coupling member may converge on the light-receiving device by the second optical element. The second optical element may be a convex lens or a Fresnel lens. Further, the holder may provide a depression into which the second optical element to be build in.

The optical module of the present invention may further include a third optical element built in a surface of the holder. The third optical element faces the light-receiving device for the second optical signal provided from the coupling member to converge on the light-receiving device. The third optical element may be a convex lens or a Fresnel lens. Further, the holder may provide a depression into which the third optical element is built in.

### BRIEF DESCRIPTION OF DRAWINGS

FIG. 1 is a perspective view showing a holder for holding a wavelength selective optical filter according to the first embodiment of the present invention;

FIG. 2A and FIG. 2B are side views showing a holder according to the second embodiment of the invention;

FIG. 3 is a perspective view of a holder according to the third embodiment of the invention;

FIG. 4A and FIG. 4B are side and plan views, respectively, of an optical module having the holder according to the present invention;

FIG. 5 is a side view showing another embodiment of the optical module according to the present invention;

FIG. 6A and FIG. 6B show layer structures of the photodiode applicable to the present optical module; and

FIG. 7 shows an arrangement of a bi-directional optical module.

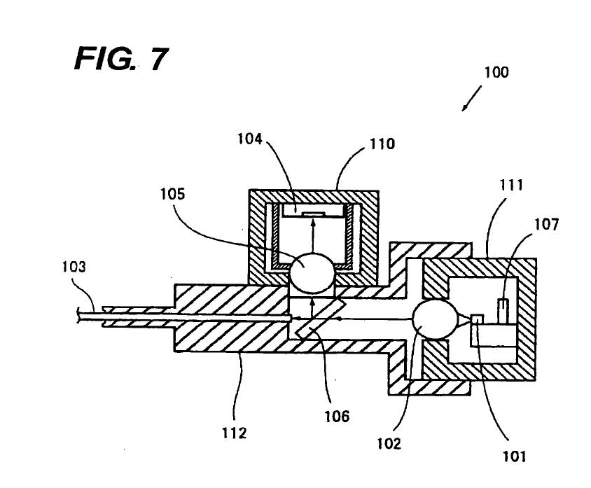

### DETAILED DESCRIPTION OF PREFERRED EMBODIMENTS

Next, preferred embodiments of the present invention will be described as referring to accompany drawings. In the drawings and specifications, the same elements will be referred by the same symbols or numerals without overlapping explanation. Dimensions in the drawings do not always reflect their practical length.

(First Embodiment)

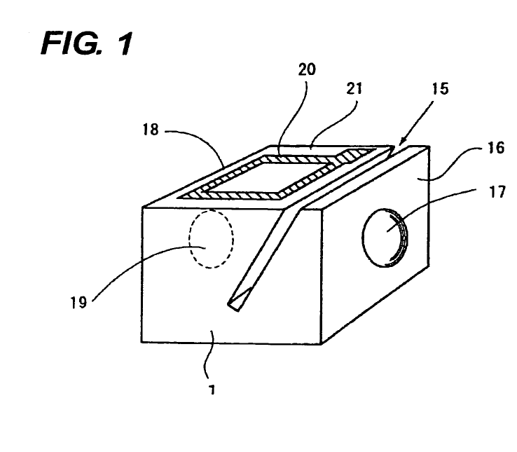

FIG 1 is a perspective view showing a holder 1 for an optical filter according to the present invention. The holder 1 provides a groove 15 for receiving the optical filter, and two convex lenses 17 and 19 on respective opposing surfaces 16 and 18 of the holder, which sandwiches the groove 15. The holder 1 further provides an interconnection 20 on a top surface 21 thereof, whose normal intersects an optical axis connecting two lenses 17 and 19. When a semiconductor light-receiving device is directly mounted on the top surface 20, such as a photodiode (hereinafter denoted as PD), a light-sensitive surface of the PD may optically couple with the second lens 19 via the optical filter disposed within the groove 15.

The holder may be typically made of silica glass, whose refractive index is about 1.46. However, the material of the holder is not restricted to the silica glass, only the limitation that the material for the holder is transparent to signal light should be considered. For example, engineering plastic and silicon may be applicable. The engineering plastic has advantages in that the molding may form the holder, thereby enabling to provide cost effective products. In the case that the holder is mode of silicon, since the refractive index of which is 3.42 greater than that of the silica glass, the focal length of the can be shortened, which enables to miniaturize the holder. Further in the case of the silicon holder, the lenses 17 and 19 provided in respective side surfaces may be formed by, in addition to the chemical etching, the fine processing technology, such as ion milling, popular in the manufacturing process of the silicon integrated circuit, which enhances the process tolerance of the lenses.

Ultimately, various circuits, such as a pre-amplifier of the optical receiving signal or a laser driver, may be integrated within the holder made of silicon.

(Second embodiment)

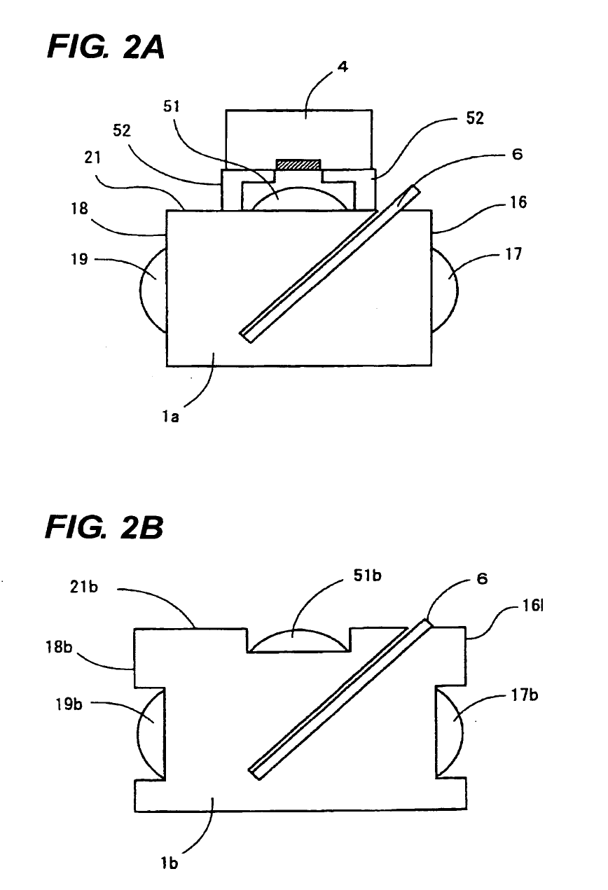

FIG. 2A and FIG. 2B are side views showing another holders 1a and 1b of the present invention. In these holders 1a and 1b, in addition to two convex lenses 17 and 19 provided in respective side surfaces thereof, a third convex lens 51 is provided on the top surface 21 of the holder to enhance an optical coupling efficiency between the second lens 19 and the PD mounted on the top surface 21. In FIG. 2A, a sub-mount 52 is provided for mounting the PD thereon to enhance the optical coupling efficiency between the PD and the second lens 19. The height of the sub-mount 52 is greater than a thickness of the third lens 51 to protect the surface thereof.

On the other hand in FIG. 2B, the holder 1b provides depressions and on respective surfaces thereof to receive convex lenses 17b, 19b and 51b therein. The tops of the convex lenses 17b, 19b and 51b are within the depressions to protect the tops thereof. Since the length between the filter within the groove 15 to the PD mounted on the top surface 21 may be shortened because of the convex lens provided on the top surface 21, the holder 1b may be miniaturized. In the holder shown in FIG. 2 in particular, the sub-mount 52 for the PD may be omitted and the PD is directly mounted on the top surface 21 thereof, which may further miniaturize the holder without causing damage on the convex lens.

(Third embodiment)

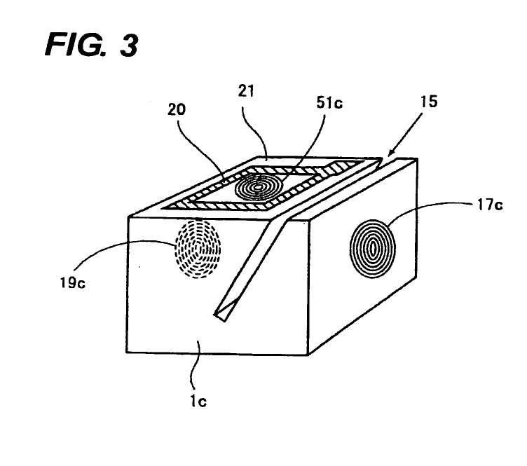

FIG. 3 is a perspective view showing another holder 1c of the present invention. In the present embodiment, two lenses 17c and 19c provided in the side surfaces and another lens 51c provided on the top surface 21 are a type of a Fresnel lens that has a diffraction grating having an uneven interval of the convex-concave. The PD is mounted on the Fresnel lens provided in the top surface 21 of the holder, whereby the PD may optically couples with the second Fresnel lens 19c via the filter disposed within the groove 15.

The Fresnel lens may be easier formed on the surface of the silicon because, as previously shown, the refractive index of the silicon is greater than that of the silica glass, the depth of the diffraction groove may be shallower which may make the process easy.

(Fourth Embodiment)

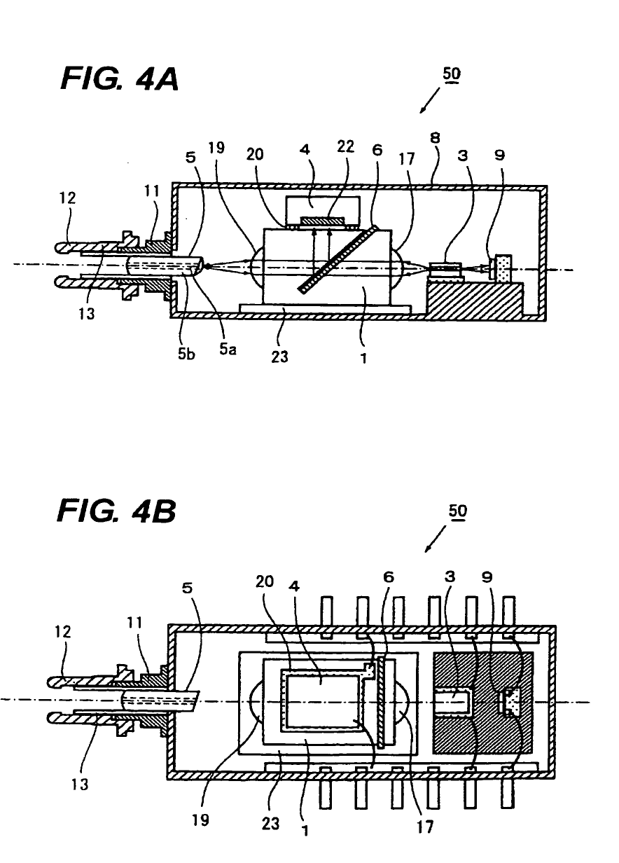

FIG. 4 shows an optical transmitting/receiving module 50 according to the fourth embodiment of the invention. The optical module 50 includes a semiconductor light-emitting device 3, a semiconductor light-receiving device 4, a coupling device 5, an optical filter 6, a holder 7, a housing 8, and a light-receiving device 9 for monitoring the light emitted from the laser. The light-transmitting device 3 may be a laser diode for emit light having a first wavelength λ₁ of 1.3 μm. The light-receiving device 4 may be a photodiode for receiving light propagated from the coupling device 5 with a second wavelength λ₂ of 1.55 μm and for converting thus receiving light into a corresponding electric signal.

The holder 1, made of silica glass the refractive index of which is about 1.46, radii of curvature are 0.0625 mm and 0.75 mm for the first lens R1 and the second lens R2, respectively. The LD is mounted about 0.1 mm apart from the top of the first lens, which is nearly focal length thereof The coupling device is disposed such that an end surface thereof is apart by about 1 mm from the top of the second lens 19, which is nearly the focal length of the second lens 19. The optical filter 6 transmits the light with the first wavelength, 1.3 μm, from the LD, while reflects the light with second wavelength, 1.55 μm, from the coupling device. The filter may be a wavelength division multiplexing (hereinafter denoted as WDM), in which a multi-layered dielectric film is coated on the silica glass

The coupling device 5 includes a coupling fiber 5a and a ferrule 5b building the coupling fiber 5a therein. An end surface thereof facing the holder is inclined to the optical axis connecting the coupling device and the holder by about 8° to suppress stray light reflected by this end surface and returning the LD again. The other end surface of the coupling fiber 5a is spherically processed to realize a physical contact with another fiber inserted from the outside and optically coupled with the coupling fiber 5a.

The coupling device 5 is secured to the housing 8 via an alignment assembly that includes an alignment member 11, a sleeve cover 12, and a sleeve 13 The sleeve 13 receives the coupling device 5 in one end thereof, while the other end of the sleeve 13 receives the ferrule of the fiber inserted from the outside of the module. Thus, within the sleeve 13, the physical contact between the coupling fiber 5a and the other fiber from the outside can be achieved. The alignment member 11 provides a flange in one end thereof facing the housing 8. By sliding the flange of the alignment member on the outer surface of the housing 8, the optical coupling between the coupling device 5 and the holder 1 can be carried out. That is, by sliding the alignment member 11 on the housing 8, the optical axis of the coupling fiber 5a can be aligned with the optical axis of the holder 1 which connects the center of the first convex lens 17 to that of the second convex lens 19.

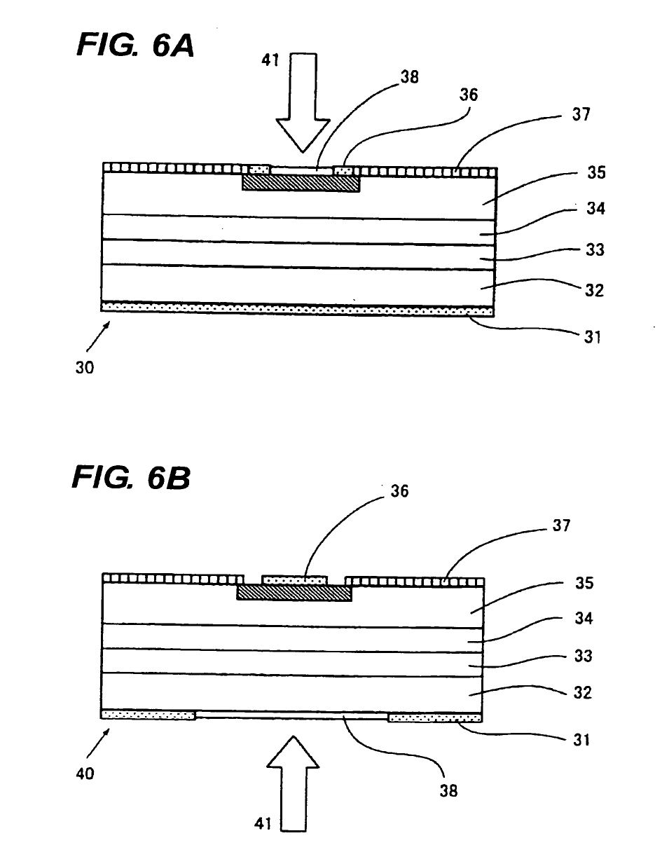

FIG. 6A and FIG. 6B are cross sectional views of typical example of the semiconductor light-receiving device 4. The semiconductor light-receiving device 4 may be a photodiode having a type of the front surface illumination, FIG. 6A, or another type of the back surface illumination, FIG. 6B. The photodiode 30, 40 includes an n-type electrode 31, an n-type InP substrate 32, an n-type Inp layer 33, an InGaAs light-sensitive layer 34, a p-type InP layer 35, and a p-type electrode 36. On the surface into which the light 41 enters is provided an anti-reflection coating 38. The light 41 is absorbed in the InGaAs light-sensitive layer 34 and a photo carrier is generated therein. Other layers of the n-type and p-type InP and the anti-reflection coating are provided for enhancing the sensitivity.

The PD shown in FIG. 6A receives the light from the side of the p-type electrode 36 opposite to the InP substrate, while the PD shown in FIG. 6B receives the light through the InP substrate. The n-type electrode 31 of the PD 40 in FIG. 6B has a pattern corresponding to the interconnection 20 provided on the top surface 21 of the holder 1, which enables to mount the PD 40 directly onto the interconnection 20, and to make unnecessary for the wire-bonding thereto.

The signal light emitted from the LD 3, which has the wavelength of 1.3 μm, optically couples with the first lens of the holder 1, is converted to a nearly parallel beam, passes the optical filter 6, and is converged to the coupling device 5 by the second lens 19 of the holder 1. On the other hand, the light provided from the coupling device 5, which has the wavelength of 1.55 μm, optically couples with the second lens 19, converted to a nearly parallel beam, reflected by the filter 6, and finally couples with the surface of the PD 4.

Thus, In the assembling of the optical module 1, the PD 4 is mounted on the top surface 21 of the holder by using the interconnection provided thereon, which simultaneously aligns the PD 4 with the coupling device 5. Therefore, the optical alignment between the receiving optical sub-assembly, the optical filter and the optical coupling device, they are indispensable for the conventional module, may be omitted, which simplifies the assembly of the module and shortens the assembling time. The lens holders provided in the transmitting optical sub-assembly and the receiving optical sub-assembly may be dispensable, which enables to miniaturize the module. Further, although it is difficult to dispose a lens between the coupling device and the optical filter, in the present invention, the holder may provides the second lens 19 on the surface thereof, which enhances the coupling efficiency between the LD 3 and the coupling device 5 and between the coupling device and the PD 4.

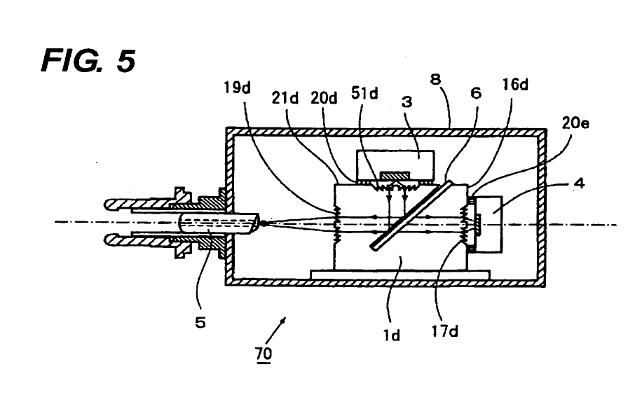

FIG. 5 shows a cross section of another optical module 70 of the present invention. In the previous optical modules, the LD and the coupling device are arranged on the identical optical axis, namely arranged in line, while the optical axis of the PD intersects the optical axis connecting the LD with the coupling device. On the other hand, in the present optical module 70 shown in FIG. 5, the LD 3 is disposed on the top surface 21d of the holder, that is the optical axis of the LD 3 intersects that of the coupling device 5. The light emitted from the LD, which has the wavelength of 1.3 μm, reaches the coupling device after passing the third Fresnel lens 51d and being reflected at the filter 6. The light provided from the coupling device 5, which has a wavelength of 1.55 μm, reaches the PD 4 disposed on the side of the holder 1d after passing the second Fresnel lens 19d, the filter 6, and the first Fresnel lens 17d. In this embodiment, the filter 6 reflects the light with the wavelength of 1.3 μm, while passes the light with the wavelength of 1.55 μm.

The LD 3 of the present embodiment may be a surface-emitting laser, which is called as a vertical cavity surface-emitting laser (VCSEL) in the field. The LD 3 is mounted on the interconnection 20d provided in the top surface 21d of the holder 1d. The third Fresnel lens 51d is also formed on the top surface 21d. Similarly, the PD 4 is mounted on the side surface 16d, where the interconnection 20e for the PD 4 and the first Fresnel lens are formed, of the holder 1d.

Since the present optical module has the holder id, the top surface 21d of which mounts the LD having the type of the VCSEL, auxiliary members such as a sub-mount for the LD can be omitted, thereby miniaturizing the housing and reducing the cost thereof. Further, the holder of the present invention provides interconnections for devices on the top surface 21d and the side surface 16d thereof, the LD and the PD can be automatically aligned with the optical axis of the Fresnel lens by mounting the LD and the PD to align with the interconnections when the interconnections are formed so as to align the optical axis of the Fresnel lens. Further, although the present embodiment provides the Fresnel lens formed on the surface of the holder, it may be considered to provide convex lenses with in the depression formed on the surface of the holder, or to provide a combination of convex lenses and Fresnel lenses both disposed on the surface of the holder.

Thus, optical modules having a holder according to the present invention are described as referring to preferable embodiments. However, the spirit of the present invention does not restricted to such embodiments explicitly shown in figures. For example, above embodiments provide the optical receptacle 10 into which the optical connector is mated from the outside of the module However, a pig-tail type connector may be also applicable, in which the coupling fiber 5a in the coupling device is extended from the end of the ferrule 5b, which is polished in convex for the physical contact with the optical connector, to the outside of the module and provides an optical connector at the extended end thereof All such modifications should be regarded within the spirit and scope of the invention. The present invention should be limited only by the scope of the apparent claims.

1. An optical module for receiving a first optical signal with a first wavelength from and transmitting a second optical signal with a second wavelength to single optical fiber in bi-directional, said optical module comprising:
an optical filter for transmitting one of said first and said second optical signals and reflecting the other of said first and second optical signals;
a holder for securing said optical filter;
a semiconductor light-receiving device for receiving said first optical signal;
a semiconductor light-emitting device for emitting said second optical signal;
a coupling member for transmitting said first optical signal and said second optical signal therein; and
a first optical element for optically coupling said semiconductor light-emitting device with said coupling member,
wherein said first optical element is built in a surface of said holder.

2. The optical module according to claim 1, wherein said optical filter transmits said first optical signal emitted from said semiconductor light-emitting device to said coupling member and reflects said second optical signal provided from said coupling member.

3. The optical module according to claim 1, wherein said optical filter transmits said second optical signal provided from said coupling member to said light-receiving device and reflects said first optical signal emitted from said semiconductor light-emitting device to said coupling device.

4. The optical module according to claim 1, wherein said holder provides a groove for securing said optical filter therein.

5. The optical module according to claim 4, wherein said groove is formed such that an optical axis of said optical filter secured in said groove is inclined by a half of a right angle to an optical axis of said coupling member.

6. The optical module according to claim 1, wherein said first optical element is a convex lens built in a surface of said holder.

7. The optical module according to claim 6, wherein said convex lens is formed in a depression provided in said surface of said holder, said semiconductor light-emitting device being mounted on said surface of said holder so as to overlay said depression.

8. The optical module according to claim 1, wherein said first optical element is a Fresnel lens provided in a surface of said holder.

9. The optical module according to claim 1, further includes a second optical element built in a surface of said holder, said surface of said holder facing said coupling member such that said semiconductor light-receiving device optically couples with said coupling member through said second optical element, and said first optical signal emitted from said semiconductor light-emitting device and converted to an substantially parallel beam converges on said coupling member by said second optical element.

10. The optical module according to claim 9, wherein said second optical element is a convex lens build in said surface of said holder.

11. The optical module according to claim 10, wherein said convex lens is formed in a depression provided in said surface of said holder.

12. The optical module according to claim 9, wherein said second optical element is a Fresnel lens provided in said surface of said holder.

13. The optical module according to claim 1, further includes a third optical element for optically coupling said semiconductor light-receiving device with sad coupling member, said third optical element being built in a surface of said holder.

14. The optical module according to claim 13, wherein said third optical element is a convex lens built in said surface of said holder.

15. The optical module according to claim 14, wherein said convex lens is formed in a depression provided in said surface of said holder, said semiconductor light-receiving device being mounted on said surface of said holder so as to overlay said depression.

16. The optical module according to claim 13, wherein said third optical element is a Fresnel lens provided in said surface of said holder.

17. The optical module according to claim 1, wherein said holder further provides an interconnection electrically connected with at least one of said semiconductor light-emitting device and said semiconductor light-receiving device.

18. The optical module according to claim 1, wherein said semiconductor light-emitting device is a laser diode, and said semiconductor light-receiving device is a photodiode.
